(19) United States
(12) Patent Application Publication
(10) Pub. No.: US 2015/0073956 A1
(43) Pub. Date: Mar. 12, 2015

(54) MODEL RISK RATING

(71) Applicant: Bank of America Corporation, Charlotte, NC (US)

(72) Inventor: Daniel Mayenberger, London (GB)

(73) Assignee: Bank of America Corporation, Charlotte, NC (US)

(21) Appl. No.: 14/021,747

(22) Filed: Sep. 9, 2013

(51) Int. Cl. G06Q 10/06; G06Q 40/00

(52) U.S. Cl. CPC G06Q 10/067; G06Q 40/00
USPC 705/35

(57) ABSTRACT

Apparatus and methods for model risk rating are provided. Model risk rating may include rating models on a scale of low potential risk, medium potential risk, high or critical potential risk. Model risk rating may include performing an assessment of model-application pairs. The assessment may include evaluating model complexity, application complexity, materiality of model use and model limitations and uncertainties. The model limitations and uncertainties may be weighted by severity. Mitigations to a model limitation may be taken into account. Apparatus and methods allow for aggregating model risk scores. A ranking of models may be determined based on the model risk scores. Scoring thresholds may be defined based on criteria of inherent potential risk, potential risk of financial losses and severity of model limitations. Based on these thresholds, each model may be classified as low potential risk, medium potential risk, high or critical potential risk.

### FIELD OF TECHNOLOGY

Aspects of the invention relate to managing potential risk associated with models deployed in financial decision making. More specifically, the invention relates to calculating a model risk score that may be aggregated across different models, different applications and different lines-of-business. Constituent components of the model risk score may also be aggregated as well.

### BACKGROUND

Bank and other financial institutions (hereinafter “banks”) are increasingly relying on models to drive decision making. A model is a mathematical algorithm which makes assumptions about certain properties. Using the assumptions, the model approximates actual properties or calculates new properties. Exemplary new properties may include present value or sensitivities with respect to market variables.

Banks may take action based on the assumptions calculated by the model. For example, banks may issue trading orders based on the assumptions calculated by a model. Models may be automated and may allow banks to automate decision making. Assumptions calculated by a model may form an input utilized by a financial product or service (hereinafter “application”). The assumptions may shape a behavior of the application.

For example, an application may include financial products which include a payoff in cash or physical commodities. The payoff may occur according to conditions that are set out in a contract template of the application. A trading application may rely on predictions of future events. The future events may be pricing, timing, current events or political events. A model associated with the trading application may receive data that is available now, and based on the data, estimate or predict an output. The application may rely on the model output in deciding how or when to trade.

Additional exemplary applications may include: (1) underwriting credits, (2) valuing exposures, instruments and positions, (3) measuring risk of other applications or bank activities, (4) managing and safeguarding client assets, (5) determining capital and reserve adequacy, and many other bank activities.

Increased reliance on model driven decision making may increase a potential risk associated with model use. Potential risk may result from faulty model decision making. Potential risk may result from erroneous model use. For example, a model may not be a good fit for a particular application. Potential risk may include potential monetary loss, loss of goodwill or other adverse consequences to those relying on a model's assumptions. Thus, as model use increases, potential model risk has increased in importance.

US bank regulators such as the Board of Governors of the Federal Reserve (FRB) and the Office of the Comptroller of the Currency (OCC) advocate in their joint supervisory guidance OCC2011-12/SR11-07 on model risk management that potential model risk be treated by banks like other known potential risks experienced by banks, such as market risk and credit risk.

The FRB/OCC further advocate that banks identify sources of potential model risk and assess a magnitude of the potential risk exposure resulting from model use. Calculating and quantifying potential model risk is not straightforward. Potential model risk may increase with greater model complexity, higher uncertainty about model inputs and model assumptions, broader model use, and larger potential impact of model use. Therefore, to accurately assess potential model risk, banks should consider risk from individual models and model use in the aggregate across lines-of-business operated by each bank.

An additional layer of complexity arises when an output of one model forms the input of another model. Models themselves may be used to measure risk of other models. The output of a model may be used by an application in conjunction with outputs of many models.

While data driven model decisioning may improve financial decision making, increased model use and intricate relationships among models deployed by banks makes it difficult to quantify a potential risk of model error. Model error may include an error in model develop, misuse of the model. Model error may be associated with costs such as financial loss or loss of goodwill, and other costs.

To accurately assess potential model risk, banks may need to determine which model is being using with which application. Furthermore, because one model may be used with numerous applications, the bank will need to assess a potential risk yielded by the combination. Therefore, it would be desirable to provide apparatus and methods for measuring potential model risk from individual models. It would further be desirable to provide apparatus and methods for measuring potential model risk in the aggregate—across a plurality of models and across a plurality of applications.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

The objects and advantages of the invention will be apparent upon consideration of the following detailed description, taken in conjunction with the accompanying drawings, in which like reference characters refer to like parts throughout, and in which:

FIG. 1 shows an illustrative apparatus in accordance with principles of the invention;

FIG. 2 shows an illustrative arrangement in accordance with principles of the invention;

FIG. 3 shows an illustrative arrangement in accordance with principles of the invention;

FIG. 4 shows an illustrative arrangement in accordance with principles of the invention;

FIG. 5 shows an illustrative arrangement in accordance with principles of the invention;

FIG. 6 shows an illustrative arrangement in accordance with principles of the invention;

FIG. 7 shows an illustrative arrangement in accordance with principles of the invention;

FIG. 8 shows illustrative information in accordance with principles of the invention;

FIG. 9 shows an illustrative process in accordance with principles of the invention; and

FIG. 10 shows an illustrative process in accordance with principles of the invention.

### DETAILED DESCRIPTION OF THE INVENTION

Apparatus and methods for measuring potential model risk are provided.

Apparatus may include an article of manufacture comprising a non-transitory computer usable medium. The medium may include computer readable program code embodied on the non-transitory computer usable medium. The code when executed by one or more processors may configure a computer to execute a method for determining a potential risk associated with a model.

A model may include a quantitative method, system or approach that applies statistical, economic, financial or mathematical theories, techniques and assumptions to process data into estimates of unknown real-world quantities. The model may be utilized by an application. When the model is utilized by the application, the model and the application may form a model-application combination or pair. The application of a model may be different for each context in which a model may be used. For example, “application” may be synonymous with a financial product. “Application” may be synonymous with an asset or liability whose balance is forecasted.

The method may include calculating a complexity (“MC”) of the model. The model complexity may correspond to intricacies of the model. Model risk may be affected by a complexity of the model. Models may be used in valuation and risk management of applications. In some embodiments a model's complexity may be determined based on a complexity of the application that utilizes the model. Model complexity may be determined regardless of whether a model's output is directly used by the application or if the model just provides the input for another model and is therefore a so-called “feeder model.”

A model may include a plurality of attributes. Each of the attributes may include criteria that affect a complexity of the model. Illustrative model attributes and associated criteria are shown below in Table 1.

TABLE 1
Illustrative Model Complexity Criteria

| Model Attribute | Attribute Criteria | Sub-criteria |
|---|---|---|
| Model Components | Type of Model | 1) SDE |
| | Components | 2) static distribution |
| | | 3) replication |
| | | 4) parameterization |
| | Number of Model | |
| | Components | |
| Stochastic | Number of stochastic | |
| Variables | variables in the model | |
| | Nature of variable | 1) Simple diffusion |
| | | 2) Mean reversion |
| | | 3) Dependencies on |
| | | other stochastic |
| | | variables |
| | | 4) Jumps in the |
| | | stochastic process |
| | | 5) Complexity of |
| | | marginal |
| | | distribution |
| Relationship | | |
| between market | | |
| observables and | | |
| model parameters | | |
| | Mappings of | 1) simple nature (1-to- |
| | relationships | 1) |
| | | 2) complex mappings (1 |
| | | to many, many to 1, |
| | | many to many) |
| | mapping analytics | 1) direct vs. implicit |
| | | 2) continuous vs. |
| | | discontinuous |
| | Correspondence of | |
| | parameters to principal | |
| | market movements | |
| Model solution | Form of Solution | 1) closed form |
| | | 2) semi-closed form |
| | | (usually numerical |
| | | integration) |
| | | 3) tree |
| | | 4) lattice |
| | | 5) Monte Carlo |
| | | simulation |
| | Solution stability | 1) stress testing |
| | | 2) sensitivity testing |
| Calibration | Number of input | 1) single choice of |
| | instruments that enter | calibration |
| | the calibration | instruments |
| | | 2) several sets of |
| | | calibration options |
| | local or global | |
| | calibration | |
| | ability to achieve a | |
| | good fit to the | |
| | calibration instruments | |
| Model | Number of parameters | 1) unique |
| parameterization | associated with the | parameterization |
| | model | 2) several equivalent |
| | Parameter attributes | parameterizations |
| | | that achieve an |
| | | identical output |
| Input density | Granularity of available | |
| | input data | |
| | extrapolation of input | |
| | data | |

The method may include calculating a complexity (“AC”) of an application that utilizes the model. The application may generate an output based on the model. The output may be a decision to take action such as trade a stock or sell an asset. Application complexity may be determined by the illustrative criteria shown below in Table 2. The application criteria shown in Table 2 do not each have a ranking. They may be considered in total. Two or more applications may be compared to determine how different they are with respect to their complexities.

TABLE 2
Illustrative Application Complexity Criteria

| Application | |
|---|---|
| Attribute | Attribute Criteria |
| Payoff | linear or non-linear |
| Complexity | payoff |
| | smooth or discontinuous |
| | payoff |
| | Path dependent payoff |
| Product Features | Local features |
| | Global features |
| Risk Factors | Payoff risk factors |
| | Pricing/sensitivity |
| | risk factors |
| Price | Direct quotes |
| Observability | Consensus data |
| | proxy data |
| | No observability |

In a preferred embodiment, model complexity and application complexity are calculated independently of each other. Separating the calculation of model and application complexity may avoid calculating a complexity for each possible model-application pair. Separating the calculation of complexities may also increase consistency across asset classes as a result of fewer data needing to be checked for consistency.

Model and application complexity may be assessed based on a scale from 1 to 5 or any suitable scale. Higher figures may represent higher complexity. A model complexity of zero may correspond to model complexity for a situation, in which an application does not require a model.

The method may include calculating a materiality (“M”). The materiality may be a potential exposure or monetary loss that may be realized if the model does not perform as expected. Materiality may be calculated in currency. For example, the materiality may be measured in USD, CAD, EUR or any suitable currency.

The method may include calculating a normalized materiality. The normalized materiality may be calculated by applying a normalizing function to a potential exposure. The normalized materiality may allow for a comparison of materiality across asset classes or lines-of-business operated by a bank. For example, every application may be assigned a score between 1 and 5 according to its size. The “larger” an application, the larger a potential risk exposure that may be associated with a failure or malfunction of a model driving the application.

Using a normalized scale when calculating materiality allows for comparability of materiality of an application-model pair across asset classes and across lines-of-business (“LOBs”). For example, using the normalized scale, a LOB may aggregate or compare potential risk for all application-models pairs deployed by the LOB. The LOB may identify a total potential risk due to models used by applications of the LOB.

The normalized materiality may correspond to a potential risk exposure that may be realized from a malfunction or misapplication of a model. The normalized M may include a materiality of the model as applied to the application. The normalized M may correspond to an assessment of a potential loss that may be realized as a result of applying a model to a particular application.

Materiality may vary with model usage. In some scenarios a bank's infrastructure may provide reporting of model use metrics for each application that uses the model. In some scenarios, alternative metrics may be derived to calculate a materiality for the application and the model used by the application. For example, materiality may be calculated by relying on expert judgment provided by a risk management function such as market risk management or credit risk management.

The method may include calculating a raw risk score. The raw risk score may correspond to:

MᵢC*AⱼC*M_{i,j}=Raw Risk Score Equation 1

In equation 1, MᵢC represents a complexity of a model i. In equation 1, AⱼC represents a complexity of an application j. In equation 1, M_{i,j} represents the normalized materiality when application j utilizes model i. The raw risk score corresponds to a product of model complexity, application complexity and materiality of the model-application pair.

For each model, a raw risk score may be calculated for each application that relies on the model. For example, a first model and a second model may each be associated with similar levels of materiality with respect to an application. However, the first model may be used by a first number of applications. The second model may be used by a second number of applications. A normalized materiality scale may allow an aggregating of the materiality of each model-application pair. Thus, if the first model is used by more complex applications or a larger number of applications than the second model, the raw risk score of the first model may be higher than the raw risk score of the second model.

For each application, a raw risk score may be calculated for each model that is used by the application. For example, a first application and a second application may each be associated with a similar level of materiality with respect to a model. The model may be used by the first application and the second application. However, the second application may utilize a plurality of models. As a result of normalizing the materiality calculation, the materiality of each model used by the second application may be aggregated. By aggregating the materiality for each model utilized by the second application, the second application may be associated with a higher raw risk score than the first application.

A model-application pair may be associated with a limitation. The model may be designed for use in a specific context or with respect to specific applications. Using the model out-of-context may expose a bank to model error and corresponding levels of model risk. When using a model, limitations of the model should be understood to avoid model error.

The limitation may affect reliability of an output generated by a model for a certain application. For example, a model may generate an output for an application based on various simplifications and assumptions. The simplifications and assumptions may present a limitation of the model for the application. As a further example, if input data received by the model does not include a sufficiently broad sampling of data representative of an application, the model may not generate a reliable output. The quantity of input data may be a limitation of the model for the application.

The method may include calculating a limitation (“L”) of a model. The limitation may be calculated based on features of an application that utilizes the model. The limitation of a model may be calculated for a specific application. One model may exhibit different limitations when used by different applications. Initially, each limitation associated with a model may be assigned a neutral weight of 1, which may be mitigated or scaled up.

Model limitations may be identified as a result of model validations. A bank may validate a model and identify limitations of a model before utilizing the model in conjunction with an application. Model limitations may be identified based on a survey conducted in an Annual Model Performance Review, which solicits feedback from all groups involved with model use with a view to uncover model insufficiencies or shortcoming that may be explained by limitations.

The limitation may be associated with a severity (“S”). The severity may “scale up” the limitation by a factor larger than one. The severity may be based on one or more model attributes. The severity may be based on a model's capabilities when utilized by an application. For example, the model may include an assumption that limits a scope of which applications may utilize the model. Using a model with an application that is not clearly within the scope of the model may increase the severity. Other circumstances which may increase the severity include audit findings or historical model failures associated with the model.

The severity may reflect uncertainty in how reliable an output of a model may be when utilized by an application. The uncertainty may be estimated. A severity may correspond to a multiplier applied to the limitation. The multiplier may reflect the estimated impact on a model output. Table 3 below shows exemplary levels of potential impact that a limitation may have on a model output. In some embodiments, a limitation may be associated with a default severity. The default severity may correspond to a “medium” level severity.

TABLE 3
Illustrative limitation severity ranges

| Impact on | Limitation | |
|---|---|---|
| model output | Severity | Multiplier |
| <=1% | Immaterial | 0 |
| >1% and <=5% | Low | 0.5 |
| >5% and <=10% | Medium | 1 |
| >10% | High | 2 |
| | Critical | 3 |

A model may be associated with two or more limitations. The method may include determining which of the limitations apply to the application that utilizes the model. The method may include calculating a severity for each of the plurality of limitations that apply to a model when utilized by an application. The method may include calculating the final potential risk based on the severity of each of the plurality of limitations that apply to the model when the model is utilized by the application. For example, a severity multiplier may be applied to each limitation of a model.

The method may include calculating a mitigation (“LM”) associated with the limitation. A mitigation may include a step or process for alleviating a model limitation. An exemplary mitigation may include development of a new model or improvement upon an existing model. A new or improved model may alleviate an impact of the limitation. The new or improved model may expand a scope of applications that may utilize the model.

An exemplary mitigation may include a valuation adjustment. Valuation adjustments correct a model output or decision for pricing models to account for specific limitations. Other exemplary mitigations may include controls, monitoring, overlays or application of other model tools showing that a model limitation may have a limited impact on an output generated by the model. Illustrative mitigations are shown below in Table 4.

TABLE 4
Illustrative Mitigations

| | Progress of | | | Potential |
|---|---|---|---|---|
| Extent of | New Model | Valuation | Other | Override by |
| Mitigation | Development | Adjustment | Mitigations | stakeholder(s) |
| 25% | in | designed | Control or | To be captured |
| | development | | other | with name(s), |
| | or | | mitigation | date & |
| | submitted | | in design or | argumentation |
| | | | development | |
| 50% | in | applied | Partial | To be captured |
| | validation | | correction or | with name(s), |
| | | | control | date & |
| | | | | argumentation |
| 75% | Approved | n/a | Restrictions, | To be captured |
| | and signed | | unless leading | with name(s), |
| | offs | | to a valuation | date & |
| | | | adjustment | argumentation |
| | | | Manual control | |
| | | | that remediates | |
| | | | the issue | |
| | | | (still | |
| | | | operational | |
| | | | risk since | |
| | | | manual) | |
| 100% | in | n/a | Automated | To be captured |
| | production | | control that | with name(s), |
| | | | remediates the | date & |
| | | | limitation | argumentation |

An extent to which a mitigation applies to a limitation may be standardized. Standardization may improve consistency in calculating a mitigation when assessing potential model risk. Additionally, a bank may apply an override if they are convinced that the standard extent of the mitigation does not accurately represent the model risk. Any such override is documented with the names of the stakeholders claiming the override and an argumentation that explains why the override is applied.

A mitigation may be one of a plurality of mitigations. When the mitigation is one of a plurality of mitigations, the method may include calculating the final potential risk score based on a maximum of the plurality of mitigations.

For example, if a limitation of a model-application pair is associated with several mitigations, each of the mitigations may not be applied cumulatively. In a preferred embodiment, the highest mitigation extent would be applied when calculating the final potential risk score. For example, a limitation of a model-application pair may be associated with two mitigations. A first mitigation may reduce an adverse effect of a limitation by 50%. A second mitigation may reduce an adverse effect of the limitation by 75%. A combined reduction as a result of applying both the first and second mitigation may lead to a reduction of 75% (the maximum of 50% and 75%) rather than to a reduction of 87.5% (resulting from 1−(1−0.5)*(1−0.75)=0.875).

Applying the maximum mitigation may result in a more conservative calculation of potential model risk. If two mitigations warrant a cumulative application, an override can be applied. The override may include an explanation of why a cumulative mitigation is warranted in a particular case.

The method may include calculating a final potential risk score. The final potential risk score may correspond to:

MᵢC*AⱼC*M_{i,j}*S_{i,j}*LM_{i,j} Equation 2

Equation 2 shows that the final potential risk score is calculated for each model i used by an application j. Equation 2 also shows that the final potential risk score is calculated for each application j that uses a model i.

An application may be one of a plurality of applications that utilize a model. When a plurality of applications utilize the model, the method may include aggregating the potential risk associated with the model and each of the plurality of applications. The aggregating may include calculating a final potential risk score for each of the plurality of applications that utilizes the models. Each application that utilizes the model may form a model-application pair with the model. The aggregating may also include calculating a summation of the final potential risk scores of each of the plurality of applications that utilize the model.

The aggregating may include calculating a complexity for each of the plurality of applications. The aggregating may include calculating a materiality of the model to each of the plurality of applications. The aggregating may include calculating a limitation of the model for each of the plurality of applications.

Apparatus may include a computer program product for calculating a potential liability for a financial model. The financial model may be selected from among a plurality of financial models. The computer program product may include a non-transitory computer readable medium having computer readable program code embodied therein. The apparatus may include a processor configured to execute the computer readable program code.

The computer readable program code (hereinafter “code”) when executed by the processor may calculate the potential liability for the financial model selected from among the plurality of financial models.

The code may calculate a complexity associated with the financial model. The code may calculate a normalized materiality of an output generated by the financial model when the financial model is embedded in an application. Embedding the financial model in the application may correspond to the application relying on the output generated by the model.

The code may calculate a complexity associated with the application. The complexity associated with the application may be determined independently from the calculating of the complexity associated with the financial model. The code may determine a limitation associated with the financial model. The limitation may be specific to the financial model when the financial model is embedded in the application. The code may calculate a severity associated with the limitation. The code may calculate a mitigation associated with the severity. The code may calculate a normalized potential liability score for the model based on a product of: the complexity of the model, the complexity of the application, the materiality, the limitation, the severity and the mitigation.

The code when executed by the processor may calculate a total potential liability score. The total potential liability score may correspond to a summation of the normalized potential liability score for each of the plurality of financial models.

When two or more of the plurality of financial models are embedded in the application, the code when executed by the processor, may calculate a total potential liability score corresponding to a summation of the normalized potential liability score of the two or more financial models embedded in the application.

When a plurality of models are embedded in a plurality of applications, the code when executed by the processor, may calculate a total potential liability score corresponding to a summation of the normalized potential liability score for each of the plurality of models that is embedded in each of the plurality of applications.

Apparatus may include a computer program product for assigning a potential risk measure to a model-application pair. The model-application pair may include (1) an application that generates an output using the model and (2) the model. The computer program product may include a non-transitory computer readable medium having computer readable program code embodied therein. The computer program product may include a processor. the processor may be configured to execute the computer readable program code.

The computer readable program code when executed by the processor may implement an algorithm. The algorithm may identify a plurality of limitations associated with a model used for a plurality of applications. The algorithm may determine which of the plurality of limitations apply to a model-application pair. The algorithm may calculate a severity for each of the plurality of limitations that apply to the model-application pair.

The algorithm may identify a mitigation associated with the model-application pair. The mitigation may be one of a plurality of mitigations. The algorithm may include calculating the potential risk measure based on a maximum value associated with the plurality of mitigations.

The algorithm may calculate a normalized materiality of the model-application pair. The algorithm may calculate the materiality of the model-application pair as a function of a change in time. At each point in time that the materiality changes, the algorithm may be configured to recalculate the potential risk measure based on the updated materiality. The algorithm may be configured to provide a bank with a substantially real time snapshot of potential risk associated with a model. The bank may deploy ameliorating strategies in the event that the calculated potential risk is higher than a risk tolerance of the bank.

The algorithm may calculate a complexity of the model. The algorithm may calculate a complexity of the application. The algorithm may calculate a normalized potential risk measure for the model-application pair based on a product of: the materiality associated with the model-application pair, the limitation of the model-application pair, the complexity of the model, the complexity of the application, the severity and the mitigation associated with limitations of the model-application pair.

The algorithm may include identifying a plurality of applications associated with the model. Each of the plurality of applications may rely on the model. An output of each of the plurality of applications may be generated using the model. The algorithm may include determining a plurality of model-application pairs based on the plurality of applications that rely on the model.

The algorithm may include, for each model-application pair, calculating the normalized potential risk measure. The algorithm may include calculating a summation of the normalized potential risk measure of each of the plurality of model-application pairs. The summation may aggregate the normalized potential risk measure for the plurality of model-application pairs. Aggregating the normalized potential risk measures may provide a total potential risk exposure for a plurality of model-application pairs. The aggregated risk score may provide a global assessment of potential risk exposure resulting from reliance on model based decision-making.

When the model-application pair is one of a plurality of model-application pairs, the algorithm may calculate a normalized potential risk measure for each model-application pair. The algorithm may include flagging each model-application pair that is associated with a normalized risk measure above a threshold. The flagging may notify a bank of model-application pairs that are associated with an excessive potential risk. The flagging may indicate a flaw in a model validation process. Upon detection of the flagged model-application pair, the bank may take corrective action to cure the flaw in the model validation process or reduce a potential risk exposure associated with the model-application pair.

The algorithm may include calculating the potential risk measure for each line-of-business (“LOB”) operated by a bank. Each LOB may utilize a model-application pair in carrying out a function of the LOB. The algorithm may select each LOB from among a plurality of LOBs operated by an entity. The algorithm may calculate a total potential risk measure for each of a plurality of model-application pairs associated with the selected LOB.

After calculating the total potential risk measure for each of the plurality of LOBs, the algorithm may identify a LOB from among the plurality of LOBs that is associated with a total potential risk measure that is higher than a risk tolerance of the LOB. The identified LOB may be associated with an unacceptable quantity of potential risk.

The following example illustrates use of apparatus and methods disclosed herein. Suppose two models, Model X and Model Y, are used in decision making at a bank. Model X and Model Y are each associated with a model complexity of “3” on a 1-5 scale. Higher values on the scale may represent higher levels of complexity. A value of “0” may correspond to a case when an application does not utilize a model.

Model X may be utilized by three Applications, A, B and C. Each of Applications A, B and C may be associated with a complexity of 2. Each of Applications A, B and C when utilizing Model X may be associated with a materiality level of $10M. This level of materiality may correspond to a medium level materiality (i.e., a level 2 on a 1-5 scale).

Model Y may be used with Application D. Application D may be associated with a complexity level of 2. When used with Model Y, a model-application pair corresponding to Model Y and Application D may be associated with a high level of materiality (i.e., a level 5 on the 1-5 scale). For example, when used with Model Y, Application D may represent a materiality level of $30M.

A first LOB may use only Applications A, B and C. A second LOB may utilize only Application D. Prior to converting a dollar value of the materiality into scores of 2 and 5 the aggregated materiality of the first LOB and second LOB may appear identical. The first LOB is associated with $10M for each of Applications A, B, C for a total of $30M. The second LOB may be associated with a single exposure of $30M associated with Application D. If a threshold for discriminating between medium and high levels of materiality is at $30M, the first and second LOB would appear to carry identical levels of materiality.

In this example we will assume that each model has only one limitation which has no mitigations and is of medium severity (i.e., a multiplier of 1). An aggregated raw risk score for the first LOB would be calculated using equation 1 above:

Raw Risk Score(Model X)=3*2*2+3*2*2+3*2*2=36 Equation 3

The raw risk score for the second LOB would also be calculated using equation 1 above:

Raw Risk Score(Model Y)=3*2*5=30 Equation 4

Overall, the first LOB which, which employs more applications (A, B and C) that each use Model X has a raw risk score that is higher (36) than that of the second LOB that only employs one Application D (risk score of 30). The aggregated potential model risk exposure may be greater when a plurality of applications all utilize one model.

As a further example, Model Z may be associated with a model complexity level of 3. Model Z may be more complex than Models X or Y as a result of differing model attributes. For example, Model Z may include an implied distribution and numerical copula solution. Model Z may be utilized by an application E. Application E may determine a price for a financial product offered by a bank. Application E may be associated with an application complexity of 5. Application E may be associated with a high level of complexity as a result of application attributes that may include multiple underlying assets and local optionality. Using Model Z to price Application E may correspond to a materiality level of 5, a high level of materiality.

Model Z may include two limitations when used to price Application E. Firstly, Model Z may be associated with a known interpolation error when used to derive the marginal distribution of underlying assets. Secondly, Model Z may be unable to calibrate to pronounced “smiles” (very high volatility for low or high strike prices with moderate volatility for strike prices around the current “at the money” price level).

The two limitations of the Model_{Z}-Application_{E} pair may be associated with two corresponding mitigations. Firstly, the limitations may only affect model performance for very low or very high strike prices which are rarely traded. Secondly, the limitations may only affect model performance under extreme market conditions. These two mitigations may reduce an impact of the limitations by 50% each. Thus, a final potential risk score for Model Z, when used by Application E and being associated with limitation #1 may be calculated using equation 2 as:

Final Potential Risk Score(M_{Z},A_{E},L₁)=3*5*5*(1−50%)=37.5 Equation 5

A final potential risk score for Model Z, when used by Application E and being associated with limitation #2 may be calculated using equation 2 as:

Final Potential Risk Score(M_{Z},A_{E},L_{Z})=3*5*5*(1−50%)=37.5 Equation 6

The calculation of the two final potential risk scores may be aggregated to determine a total final risk score for Model Z, when used by Application E and associated with Limitation Nos. 1 and 2. The total final potential risk score is:

Total Final Potential Risk Score (M_{Z},A_{E},L₁,L₂)=37.5+37.5=75 Equation 7

In conjunction with a given ranking of potential risk posed by other models, a potential risk score of “75” may correspond to a relatively low model risk rating.

An algorithm for calculating a total potential risk score across a plurality of models, applications and limitations may be abstracted using the following mathematical formulation.

With M defining the set of models, A the set of applications (products), and L the set of limitations, we denote the complexity of models and applications with

c_{M}:M→{1, . . . , 5},C_{A}:A→{1, . . . , 5} Equation 8

respectively, where for a specific model mεM the applications of that model are denoted by:

MA(m)⊂A Equation 9

By the function

e:M×A→[0,∞) Equation 10

The dollar exposure or materiality of a model is associated with a model-application pair. Translation into a normed exposure is defined by the function:

n:[0,∞)→[0,∞) Equation 11

The function n may preferably have n(0)=0 and be monotonously increasing, but need not be strictly so, because binning into discrete values of normed exposure values may lead to intervals on which n is flat.

By the above definition of applications for certain models the dollar exposure is only relevant for a pair:

$$( m , a ) ∈ {⋃}_{m ∈ M} ( \{ m \} \times MA ( m ) ) \qquad Equation 12$$

For all other pairs e(m,a) is formally set to zero.

Every model-application pair has certain limitations, which can be expressed by a function:

LA:M×A→2^{L}, Equation 13

Where 2^{L} denotes the set of all subsets of L. Every limitation has, dependent on its model and application a severity, which is defined by a function:

s:M×A×L→[0,∞) Equation 14

Outside the set ∪_{mεM}({m}×MA(m)×LA(m,MA(m))) the values for s are formally set to zero.

All mitigations for a triplet of model, product and limitation are defined on the same cartesic product by:

d₁:M×A×L→[0,1],Iε{n,v,c,o} Equation 15

Different types of exemplary mitigations are signified by n for new models, v for (valuation) adjustments, c for additional controls, and o for mitigations overrides. Usually mitigations take values larger than zero. If a certain type of mitigation is undefined it may preferably be formally set to zero to lighten the notation.

By definition of the mitigations, only the one with the highest extent prevails, implying in particular that mitigations preferably do not apply cumulatively. In addition, regardless of other types of mitigations, an overriding mitigation is definitive for the final mitigation value. So the final mitigation can be written as:

$$d \text{:} M \times A \times L \to [ 0 , 1 ] , \\ d ( m , a , l ) ≡ \{ \begin{matrix}max \{ {d}_{n} ( m , a , l ) , {d}_{v} ( m , a , l ) , {d}_{c} ( m , a , l ) \} ; & {d}_{o} ( m , a , l ) = 0 \\ {d}_{o} ( m , a , l ) ; & {d}_{o} ( m , a , l ) \neq 0\end{matrix} \qquad Equation 16$$

With the above definitions, any admissible model risk score for model mεM is defined through a function that is:
Preferably strictly increasing in complexity of both products and applications,
Preferably strictly increasing in exposure,
Preferably strictly increasing in the number of limitations and their severity, and
Preferably strictly decreasing in the mitigations on limitations.

To precisely define such a score for each model, the model-application pairs are preferably worked out using the function MA, and then the limitations and their mitigations may be determined by the function LA. As usual, IR denotes the set of real numbers and IRⁿ the n-dimensional vector space over the field of real numbers IR. Using the embedding jₘ of a vector from IRⁿ into IR^{m} with m≧n which “copies” the first n coordinates and pads the rest with zeroes, this can be expressed by a first auxiliary function:

D:M→M×2^{A}×2^{L}×{1, . . . , 5}×{1, . . . , 5}^{A}≡DM Equation 17

which is defined as:

$$D ( m ) = ( m , MA ( m ) , LA ( m , MA ( m ) ) , {c}_{M} ( m ) , {\prod }_{a ∈ A} {c}_{A} ( a ) ) \qquad Equation 18$$

The product in the last component of the function is a cartesic product, not the multiplication).
and a second auxiliary function:

E:DM→IR^{|A|}×IR^{|A∥L|}×IR^{|A∥L|}×IR×IR^{|A|}≡EM Equation 19

which is defined as:

$$E ( x , Y , Z , p , Q ) = ( {j}_{\vert A \vert} ( {\prod }_{y ∈ Y} n ( e ( x , y ) ) ) , {j}_{\vert A \vert \vert L \vert} ( {\prod }_{y ∈ Y} {\prod }_{z ∈ Z} s ( x , y , z ) ) , {j}_{\vert A \vert \vert L \vert} ( {\prod }_{y ∈ Y} {\prod }_{z ∈ Z} d ( x , y , z ) ) , p , {j}_{\vert A \vert} ( {\prod }_{q ∈ Q} {c}_{A} ( q ) ) ) \qquad Equation 20$$

where, again, all products are cartesic ones, not multiplications.

With this, an admissible score is described through a function:

ƒ:EM→[0,∞),ƒ:(α,β,γ,p,δ) [symbol] ƒ(α,β,γ,p,δ) Equation 21

that is preferably strictly increasing in p and each component of the vectors α, β, δ and preferably strictly decreasing in each component of the vector γ.

One possible choice for f is:

$$f ( α , β , γ , p , δ ) = p {\sum }_{i = 1}^{\vert A \vert} {δ}_{i} {α}_{i} {\sum }_{j = 1}^{\vert A \vert \vert L \vert} {β}_{j} ( 1 - {γ}_{j} ) \qquad Equation 22$$

Overall, for a model mεM, this choice can be written fully as a score S:

$$S ( m ) = f ( E ( D ( m ) ) ) = {c}_{M} ( m ) {\sum }_{a ∈ MA ( m )} {c}_{A} ( a ) n ( e ( m , a ) ) {\sum }_{l ∈ LA ( m , a )} s ( m , a , l ) ( 1 - d ( m , a , l ) ) \qquad Equation 23$$

Another admissible model risk score may be defined by:

$$f ( α , β , γ , p , δ ) = p {\prod }_{i = 1}^{\vert A \vert} ( 1 + {δ}_{i} ) ( 1 + {α}_{i} ) {\prod }_{j = 1}^{\vert A \vert \vert L \vert} ( 1 + {β}_{j} ) ( 2 - {γ}_{j} ) \qquad Equation 22$$

A second stage of scoring is defined by thresholds 0<T_{L}<T_{M} in conjunction with an admissible model risk score S. For any model mεM, the model risk rating may correspond to:

Low level of potential risk: if S(m)≦T_{L};

Medium level of potential risk: if T_{L}<S(m)≦T_{M}; and

High level of potential risk: if T_{M}<S(m).

For a pair (m,a)ε∪_{mεM}({m}×MA(m)), the materiality or exposure e(m,a) is normed by the function n for easier comparability and transparency into standard buckets 1 through 5. If there are numerous exposures of very low materiality or few exposures of very high materiality, this can lead to distortions. To avoid this, the following algorithm is preferably applied to define additional buckets as required.

In some cases, there may many exposures of “low materiality.” Low materiality may be evaluated based on a risk tolerance of a LOB.

In cases on “low materiality” in a subset LM⊂∪_{mεM}({m}×MA(m)) of exposures there may exist at least one pair (m*,a*)ε∪_{mεM}({m}×MA(m)) such that

$$\begin{matrix}{\sum }_{( m , a ) ∈ LM} e ( m , a ) \leq e ( {m}^{*} , {a}^{*} ) \\ but & Equation 25 \\ {\sum }_{( m , a ) ∈ LM} n ( e ( m , a ) ) > n ( e ( {m}^{*} , {a}^{*} ) ) & Equation 26\end{matrix}$$

In such a scenario, the normalizing function distorts an actual exposure. The distortion may “magnify” a total potential risk exposure.

For example, a first model may be utilized by twenty applications. Each of the first plurality of applications, when utilizing the first model, may be associated with a materiality or exposure of 1¢. A normalizing function may assign an exposure a rating between 1 and 5 to each model-application pair. Because a lowest rating on the normalized scale is a 1, each of the first plurality of applications that utilize the first model may be assigned the lowest normalized exposure rating of “one.” Aggregating the exposures for each model-application pair, the first model may be associated with a total normalized exposure of “20”, a “one” for each of the twenty 1¢ exposures.

A second model may be utilized by one application. The one application, when utilizing the model may be associated with a materiality or exposure of $50. The exposure of $50 may correspond to a rating of 2 on the normalized exposure scale. Without expanding the normalized exposure scale, the first model may be associated with a higher normalized exposure (“20”) than the second model (“2”) even though the underlying exposure of the first model is 20¢ and the underlying exposure of the second model is $50.

In cases that satisfy a distortion threshold for low materiality scenarios that “magnify” the normalized exposure, for the subset LM, the normed exposure may be re-defined for all pairs (m,a)εLM as an extended normed exposure defined by:

n*(e(m,a))=10^{-k}n(e(m,a)) Equation 27

with k large enough such that

$${\sum }_{( m , a ) ∈ LM} {n}^{*} ( e ( m , a ) ) \leq n ( e ( {m}^{*} , {a}^{*} ) ) \qquad Equation 28$$

When k is large enough, the normalized exposure may reflect to the risk represented by the “raw” exposure prior to applying the normalizing function.

In some cases, there may exist model-application pairs (m,a),(m*,a*)ε∪_{mεM}({m}×MA(m)) such that:

$$10 \frac{n ( e ( {m}^{*} , {a}^{*} ) )}{n ( e ( m , a ) )} < \frac{e ( {m}^{*} , {a}^{*} )}{e ( m , a )} \qquad Equation 29$$

In this case, the normalizing function “hides” potential risk exhibited by a model-application pair. To expose potential risk “hidden” by the normalizing function, an extended normed exposure for the pair is defined as:

n*(e(m*,a*))=10^{k}n(e(m*,a*)) Equation 30

with k large enough such that:

$$10 \frac{{n}^{*} ( e ( {m}^{*} , {a}^{*} ) )}{n ( e ( m , a ) )} \geq \frac{e ( {m}^{*} , {a}^{*} )}{e ( m , a )} \qquad Equation 31$$

For example, a first model-application pair may be associated with an exposure of $10M. On the normalized exposure scale, a $10M may be assigned the highest rating of “5.” A second model-application pair may be associated with an exposure of $100M. On the normalized exposure scale, a $100M may also be assigned the highest rating of “5.” In this case, assigning the $10M exposure and the $100M exposure a “5” may not adequately capture a difference between the exposure of the first model-application pair and the exposure of the second model-application pair. In this scenario, expanding the normalized exposure scale above “5” may capture the distinction between the exposure of the first model-application pair and the exposure of the second model-application pair.

Apparatus and methods for an expanded range model risk rating are provided. Apparatus may include an article of manufacture including a non-transitory computer usable medium having computer readable program code embodied therein. The code when executed by one or more processors may configure a computer to execute a method for expanding the range of a model risk rating.

Methods for determining a potential exposure associated with a model-application pair (“(m,a)”) are provided. The methods may include calculating a complexity (“C_{M}”) of a model (“M”) part of a model-application pair. The methods may include calculating a complexity (“C_{A}”) of an application (“A”) part of the model-application pair. The methods may include calculating an exposure (“e(m,a)”) of the model-application pair. The methods may include applying a normalizing function to the exposure to obtain a normalized exposure (“n(e(m,a))”).

If applying the normalizing function distorts the exposure by a distortion level less than a threshold distortion, the methods may include calculating a raw risk score corresponding to C_{M}*C_{A}*n(e(m,a)). If the normalizing function distorts the exposure by a distortion level greater than the threshold distortion, the methods may include: (1) applying an extended range normalizing function (“EXTn(e(m,a))”) to the exposure, and (2) calculating a raw risk score corresponding to C_{M}*C_{A}*EXTn(e(m,a)).

The normalizing function may distort the exposure in a manner that magnifies an exposure when a plurality of model-application pairs are aggregated. When applying the normalizing function magnifies the aggregated exposure, for a model-application pair (m,a) included in the plurality of model-application pairs, after applying the extended range normalizing function EXTn(e(m,a)):

e(m,a)<n(e(m,a)); and

EXTn(e(m,a))<n(e(m,a)).

The model-application pair (m,a) may be a first model-application pair (m,a)₁. The methods may include applying the normalizing function to a second model-application pair (m,a)₂. If

$$10 \frac{n ( {e ( m , a )}_{1} )}{n ( {e ( m , a )}_{2} )} < \frac{{e ( m , a )}_{1}}{{e ( m , a )}_{2}} ,$$

the methods may include applying the extended range normalizing function to e(m,a)₁. A threshold distortion level may be exceeded when:

$$10 \frac{n ( {e ( m , a )}_{1} )}{n ( {e ( m , a )}_{2} )} < \frac{{e ( m , a )}_{1}}{{e ( m , a )}_{2}} .$$

The extended range normalizing function EXTn(e(m,a)₁) may correspond to: 10^{k}n(e(m,a)₁). The variable k may be selected such that

$$10 \frac{n ( {e ( m , a )}_{1} )}{n ( {e ( m , a )}_{2} )} \geq \frac{{e ( m , a )}_{1}}{{e ( m , a )}_{2}} .$$

When an application (“a”) is one of a plurality of applications (“A”) and the model-application pair (m,a) is a first model-application pair (m,a)₁, the methods may include applying the normalizing function to a second model-application pair (m,a)₂. If Σₐ^{A}e(m,a)₁≦e(m,a)₂, and Σₐ^{A}n(e(m,a)₁)>n(e(m,a)₂), then EXTn(e(m,a)₁) may correspond to 10^{-k}n(e(m,a)₁). The variable k may be large enough such that Σₐ^{A}EXTn(e(m,a)₁)≦n(e(m,a)₂).

A threshold distortion level may be exceeded when:

Σₐ^{A}e(m,a)₁≦e(m,a)₂; and

Σₐ^{A}n(e(m,a)₁)>n(e(m,a)₂).

In scenarios when the threshold distortion level is exceeded, the extended range normalizing function may be applied the exposure of a plurality of model-application pairs. In scenarios when the threshold distortion level is exceeded, the extended range normalizing function may be applied to the exposure of one model-application pair. The one model-application pair may be associated with an “outlying” exposure.

Methods for determining a normalized exposure of a model-application pair are provided. The methods may include determining an exposure of the model-application pair.

The methods may include applying a first normalizing function to the exposure. If applying the first normalizing function distorts the exposure by a distortion level less than a threshold amount, the methods may include calculating an exposure score based on a result of the applying of the first normalizing function to the exposure.

If applying the first normalizing function distorts the exposure by more than a threshold amount, the methods may include applying a second normalizing function to the exposure. The second normalizing function may be configured to scale-up values determined by applying the first normalizing function. The methods may include applying the second normalizing function to the exposure. The methods may include calculating the exposure score based on a result of applying the second normalizing function to the exposure.

The methods may include extending a range of the first normalizing function below a minimum associated with the first normalizing function. The methods may include extending a range of the first normalizing function above a maximum associated with the first normalizing function.

For example, a result of applying the first normalizing function to the exposure may correspond to assigning the exposure a number between 1 and 5. Applying the first normalizing function may distort the exposure by more than a threshold amount. Extending range of the second normalizing function may include assigning a number between 0 and 1 to the exposure.

A result of applying the first normalizing function to the exposure may correspond to assigning the exposure a number between 1 and 5. Applying the first normalizing function may distort the exposure by more than a threshold amount. Extending the range of the second normalizing function may include assigning the exposure a number greater than 5.

A model may be a first model mᵢ. The first model mᵢ may be a member of a set of models M_{i,j}. The first model mᵢ may be applied to a first set of applications (“Aᵢ”). The first model mᵢ may be associated with an exposure Eᵢ when applied to Aᵢ.

The set M_{i,j} may include a second model (“mⱼ”). The second model mⱼ may be applied to a second set of applications (“Aⱼ”). The second model mⱼ may be associated with an exposure Eⱼ when applied to Aⱼ.

If Eᵢ≦Eⱼ, and applying the first normalizing function results in: Normalized(Eᵢ)>Normalized(Eⱼ), then the methods may include applying the second normalizing function to Eᵢ.

If applying the first normalizing function results in

$$10 \frac{Normalized ( {E}_{j} )}{Normalized ( {E}_{i} )} < \frac{{E}_{j}}{{E}_{i}} ,$$

then the methods may include apply the second normalizing function to Eⱼ.

Methods of evaluating a potential exposure to an entity are provided. The entity may be utilize a first model paired to a first plurality of applications. The entity may utilize a second model paired to a second plurality of applications.

The methods may include calculating a potential exposure of the entity associated with the first model. The methods may include calculating a potential exposure of the entity associated with the second model. The methods may include applying a first normalizing function to the potential exposure of the first model. The methods may include applying a second normalizing function to the potential exposure of the second model.

If, (1) the potential exposure of the first model is less than the potential exposure of the second model, and (2) a result of applying the first normalizing function to the potential exposure of the first model is greater than a result of applying the first normalizing function to the potential exposure of the second model, the methods may include applying a second normalizing function to the potential exposure of the first model. The methods may include applying the second normalizing function to the potential exposure of the second model.

The second normalizing function may extend a range of values associated with a result generated by applying the first normalizing function. The second normalizing function may correspond to product of 10^{-k} and the first normalizing function. The value of k may be large enough such that a result of applying the second normalizing function to the potential exposure associated with the first model is less than or equal to a result of applying the second normalizing function to the potential exposure associated with the second model.

If, (1) a quotient of the potential exposure of the second model divided by the potential exposure of the first model is greater than ten times a quotient of a result of applying the first normalizing function to the potential exposure of the second model divided by a result of applying the first normalizing function to the potential exposure of the first model, the methods may include applying a second normalizing function to the potential exposure of the second model.

The second normalizing function may correspond to product of 10^{k} and the first normalizing function. The value of k may be large enough such that a value ten times the quotient of (1) the result of applying the second normalizing function to the potential exposure of the second model divided by (2) the result of applying the first normalizing function to the potential exposure of the first model, is greater than the quotient of (2) the potential exposure associated with the second model divided by (3) the potential exposure associated with the first model.

Illustrative embodiments of apparatus and methods in accordance with the principles of the invention will now be described with reference to the accompanying drawings, which form a part hereof. It is to be understood that other embodiments may be utilized and that structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

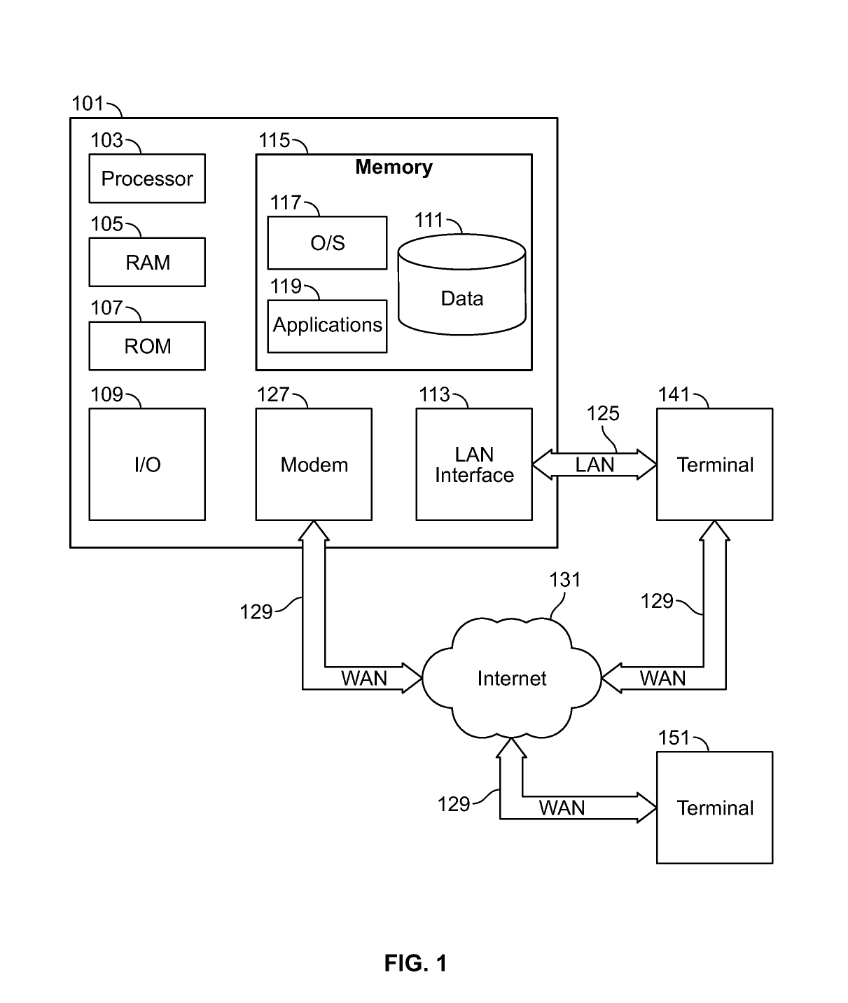

FIG. 1 is a block diagram that illustrates a computing device 101 (alternatively referred to herein as a “server or computer”) that may be used according to an illustrative embodiment of the invention. The computer server 101 may have a processor 103 for controlling overall operation of the server and its associated components, including RAM 105, ROM 107, input/output (“I/O”) module 109, and memory 115.

I/O module 109 may include a microphone, keypad, touch screen and/or stylus through which a user of device 101 may provide input, and may also include one or more of a speaker for providing audio output and a video display device for providing textual, audiovisual and/or graphical output. Software may be stored within memory 115 and/or other storage (not shown) to provide instructions to processor 103 for enabling server 101 to perform various functions. For example, memory 115 may store software used by server 101, such as an operating system 117, application programs 119, and an associated database 111. Alternatively, some or all of computer executable instructions of server 101 may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown). Terminal 151 and/or terminal 141 may be portable devices such as a laptop, tablet, smartphone or any other suitable device for receiving, storing, transmitting and/or displaying relevant information.

Any information described above in connection with database 111, and any other suitable information, may be stored in memory 115. One or more of applications 119 may include one or more algorithms that may be used to receive model information, receive application information, calculate complexities, calculate potential exposures, identify distortions in materiality calculations, generate normalizing functions and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

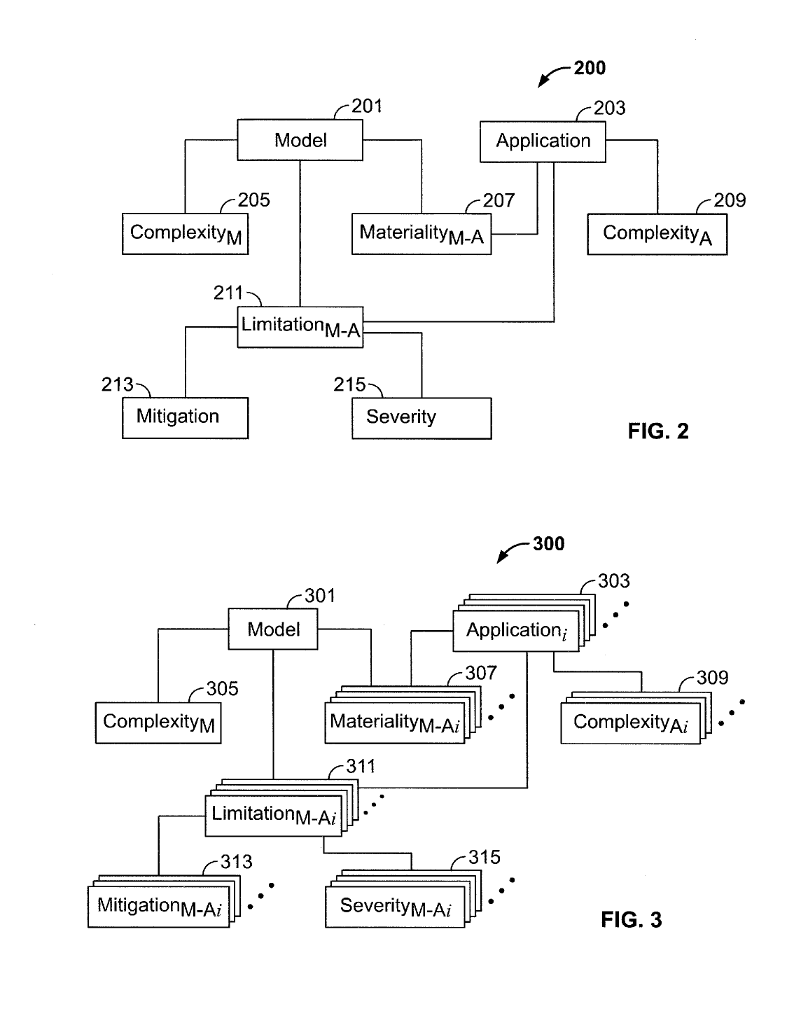

FIG. 2 shows illustrative arrangement 200. Arrangement 200 includes model 201. Model 201 may be a quantitative method, system or approach that applies statistical, economic, financial or mathematical theories, techniques and assumptions to process input data into estimates of unknown real-world quantities. Model 201 is associated with complexity 205. Complexity 205 may be determined based on one or more model attributes. Illustrative model attributes are shown above in Table 1. The complexity of a model may contribute to a potential risk exposure associated with the model.

Arrangement 200 includes application 203. Application 203 is associated with complexity 209. Complexity 209 may be determined based on one or more application attributes. Illustrative application attributes are shown above in Table 2.

Application 203 may be implemented using model 201. For example, application 203 may include pricing of products, calculation of risks or scoring of creditworthiness. Application 203 may utilize model 201 to generate a price, a risk or credit score. Implementing application 203 using model 201 may classify model 201 and application 203 as a “model-application pair.” The model₂₀₁-application₂₀₃ pair is associated with materiality 207.

Materiality 207 corresponds to a materiality or exposure to a bank when model 201 is applied to application 203. For example, if applying model 201 to application 203 is associated with a decision valued at $10 k, materiality 207 may be calculated to be a low or immaterial exposure. If applying model 201 to application is associated with a decision valued at $100M, materiality 207 may be high.

The Model₂₀₁-application₂₀₁ pair is associated with limitation 211. Limitation 211 may be identified based on a model verification process. For example, model 201 may have been designed assuming a threshold quantity of input data. If there is a paucity of input data, model 201 may not perform as expected. The quantity of input data available to model 201 may correspond to limitation 211.

Limitation 211 may be associated with mitigation 213. Mitigation 213 may alleviate an impact of limitation 211. Mitigation 213 may include development of new model upon an existing model, a valuation adjustment, or other controls limiting an impact of limitation 211.

Limitation 211 may be associated with severity 215. Severity 215 may scale up an impact of limitation 211. Severity 215 may result from systematic model failures or adverse audit findings associated with the model₂₀₁-application₂₀₃ pair.

Complexity 205, complexity 209, materiality 207, limitation 211, mitigation 213 and severity 215 may be used to determine a potential risk exposure associated with the model₂₀₁-application₂₀₃ pair.

FIG. 3 shows illustrative arrangement 300. Arrangement 300 shows model 301. Model 301 is associated with a complexity 305. Model 301 may generate an output utilized by plurality of applications 303. Plurality of applications 303 may be associated with plurality of complexities 309. Plurality of complexities 309 may include a complexity corresponding to each application included in plurality of applications 303. For example, complexityᵢ, corresponds to applicationᵢ.

Each application included in plurality of applications 309 may utilize the output generated by model 301. For example, model 301 and an applicationᵢ may form a model₃₀₁-applicationᵢ pair. Each model₃₀₁-application₃₀₃ pair may be associated with a materiality. For example, model₃₀₁-applicationᵢ pair is associated with materiality_{M-Ai}. Materiality_{M-Ai} may be included in plurality of materialities 307.

Each model₃₀₁-application₃₀₃ pair may be associated with a limitation. For example, model₃₀₁-applicationᵢ pair is associated with limitation_{M-Ai}. Limitation_{M-Ai} may be included in plurality of limitations 311. Each model₃₀₁-application₃₀₃ pair may be associated with a mitigation. For example, model₃₀₁-applicationᵢ pair is associated with mitigation_{M-Ai}. Mitigations_{M-Ai} may be included in plurality of mitigations 313. Each model₃₀₁-application₃₀₃ pair may be associated with a severity. For example, model₃₀₁-applicationᵢ pair is associated with severity_{M-Ai}. Severity_{M-Ai} may be included in plurality of severities 315.

An aggregated potential risk exposure associated with model 301 may be determined by calculating a potential risk for each model₃₀₁-applications₃₀₃ pair. The potential risk associated with each model₃₀₁-application₃₀₃ pair may be aggregated across each of applications 303 that utilizes model 301. The aggregated potential risk may correspond to a total risk or exposure associated with model 301.

The potential risk for each model₃₀₁-applications₃₀₃ pair may be a normalized potential risk. The normalized potential risk may allow for comparing aggregated potential risks associated with different models and/or different applications.

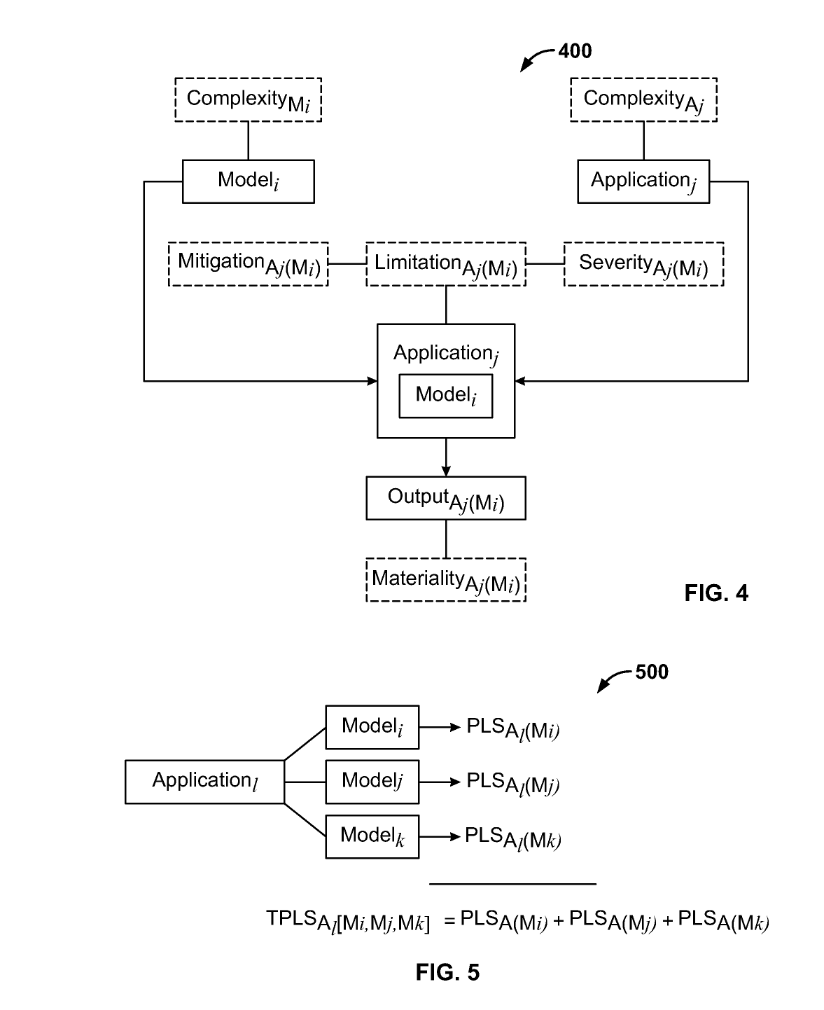

FIG. 4 shows illustrative arrangement 400. Arrangement 400 includes modelᵢ. Modelᵢ may be one of a plurality of models_{i . . . I}. Each of models_{i . . . I} may be associated with a complexity. For example, modelᵢ is associated with complexity_{Mi}. Each of models_{i . . . I} may be associated with an application. For example, modelᵢ is associated with applicaitonⱼ. Applicationⱼ may be one of a plurality of applications_{j . . . J}. Each application_{j . . . J} may be associated with a complexity. For example, applications is associated with complexity_{Aj}.

Each of models_{i . . . I} may be embedded into an application_{j . . . J}. For example, embedding modelᵢ into applications may form a modelᵢ-applicationⱼ pair. The modelᵢ-applicationⱼ pair may be one of a plurality of a model_{i . . . I}-application_{j . . . J} pairs.

Each model_{i . . . I}-application_{j . . . J} pair may generate an output. For example, The modelᵢ-applicationⱼ pair generates output_{Aj(Mi)}. The output_{Aj(Mi)} may be associated with a materiality. For example, the modelᵢ-applicationⱼ pair may be used to determine a present value of an underlying asset. The materiality may correspond to the present value. The materiality may represent a value of a potential risk if the model or model-application pair does not perform as expected.

Each model_{i . . . I}-application_{j . . . J} pair may be associated with a limitation. For example, the modelᵢ-applicationⱼ pair is associated with limitation_{Aj(Mi)}. Limitation_{Aj(Mi)} may be associated with a mitigation_{Aj(Mi)}. The limitation_{Aj(Mi)} may be associated with a severity_{Aj(Mi)}.

A potential risk score or rating may be determined for each model_{i . . . I}-application_{j . . . J} pair. The potential risk score for all model_{i . . . I}-application_{j . . . J} pairs may be aggregated. The aggregated risk score may correspond to a potential risk exposure associated with all model_{i . . . I}-application_{j . . . J} pairs.

FIG. 5 shows illustrative arrangement 500. Arrangement 500 shows applicationₗ utilizing three models: modelᵢ, modelⱼ and modelₖ. Each model utilized by applicationₗ may be associated with a potential liability score (“PLS”). Modelₗ is associated with PLS_{Al(Mi)}. Modelⱼ is associated with PLS_{Al(Mj)}. Modelₖ is associated with PLS_{Al(Mk)}. Each PLS may be aggregated to form a total potential liability score (“TPLS”) for all the three models utilized by applicationₗ.

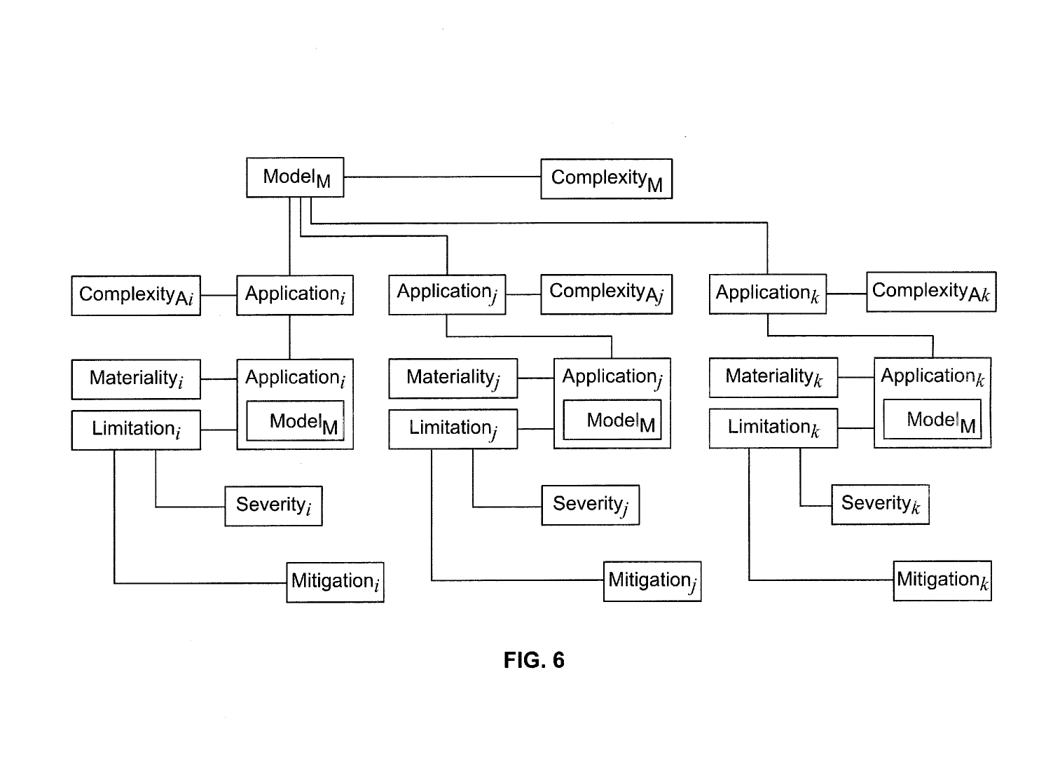

FIG. 6 shows illustrative arrangement 600. Arrangement 600 includes modelₘ. Modelₘ is associated with complexityₘ. Modelₘ is utilized by three applications: applicationᵢ, applicationⱼ and applicationₖ. Modelₘ and applicationᵢ may form a modelₘ-applicationᵢ pair. Modelₘ and applicationⱼ may form a modelₘ-applicationⱼ pair. Modelₘ and applicationₖ may form a modelₘ-applicationₖ pair.

Each model-application pair may be associated with a materiality and a limitation. The limitation may include a plurality of limitations. Each limitation may be associated with a severity. Each limitation may be associated with a mitigation. The severity may include a plurality of severities. The mitigation may include a plurality of mitigations.

A potential liability or risk score may be calculated for each model-application pair shown in arrangement 600. The potential liability or risk score of each model-application pair may be aggregated to calculate a total potential liability score for modelₘ.

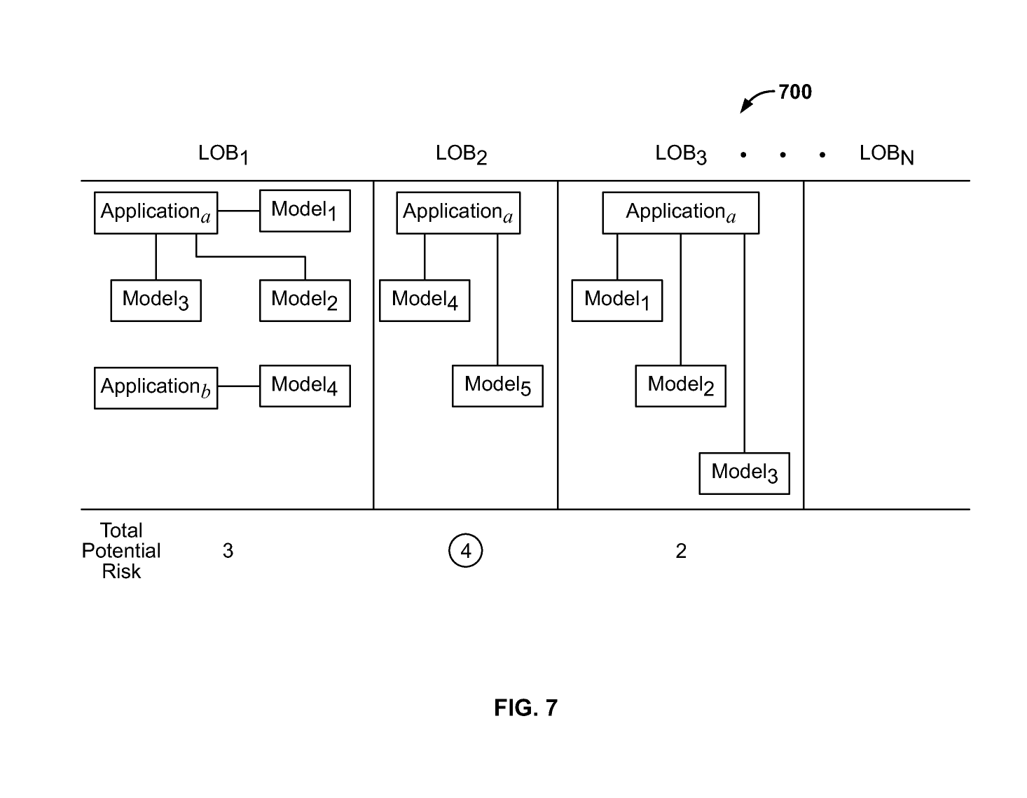

FIG. 7 shows illustrative information 700. Information 700 shows that line-of-businessₗ (“LOB₁”) utilizes two applications, a and b. Applicationₐ utilizes three models, model₁, model₂ and model₃. Application_{b} utilizes one model, model₄. LOB₁ is therefore associated with four model-application pairs: model₁-applicationₐ, model₂-applicationₐ, model₃-applicationₐ and model₄-application_{b}. A potential risk score may be calculated for each model-application pair associated with LOB₁. The potential risk score of each model-application pair associated with LOB₁ may be aggregated to calculate a total potential risk score for LOB₁. Information 700 shows that the total risk score associated with LOB₁ is “3.” The total risk score may be a normalized value.

Information 700 shows that LOB₂ utilizes one application, applicationₐ. Applicationₐ utilizes two models, model₄ and model₅. LOB₂ is therefore associated with two model-application pairs: model₄-applicationₐ and model₅-applicationₐ. A potential risk score may be calculated for each model-application pair associated with LOB₂. The potential risk score of each model-application pair associated with LOB₂ may be aggregated to calculate a total potential risk score. Information 700 shows that the total risk score associated with LOB₂ is “4.” The total risk score may be a normalized value.

Information 700 shows that LOB₃ utilizes one application, applicationₐ. Applicationₐ utilizes three models, model₁, model₂ and model₃. LOB₃ is therefore associated with three model-application pairs: model₁-applicationₐ, model₂-applicationₐ and model₃-applicationₐ. A potential risk score may be calculated for each model-application pair associated with LOB₃. The potential risk score of each model-application pair associated with LOB₃ may be aggregated to calculate a total potential risk score. Information 700 shows that the total risk score associated with LOB₃ is “2.” The total risk score may be a normalized value.

Information 700 shows that the total potential risk score differs for each of LOBs₁₋₃. Information 700 shows that LOB₁ utilizes four model-application pairs and has a total risk score of three. LOB₂ utilizes one model-application pair and has a total risk score of four. A difference in total risk score may result from differences in complexity, materiality or limitations associated with a model-application pair.

The total risk score of each of LOB₁₋₃ may be aggregated. Aggregating the total risk scores for each of LOB₁₋₃ may provide a risk score for all model-application pairs utilized by an entity that operates LOB₁₋₃. An entity that operates LOB₁₋₃ may be associated with a potential risk score of “9” (3+4+2). A risk score of “9” may translate into one of four categories:

Low: Little intrinsic risk or low associated materiality;
Medium: Some limitations, material exposure or chances of loss/adverse decisions;
High: Inherent risk, significant exposure and risk of financial losses; or
Critical: High model risk and elevated exposure or systemic importance or regulatory focus.

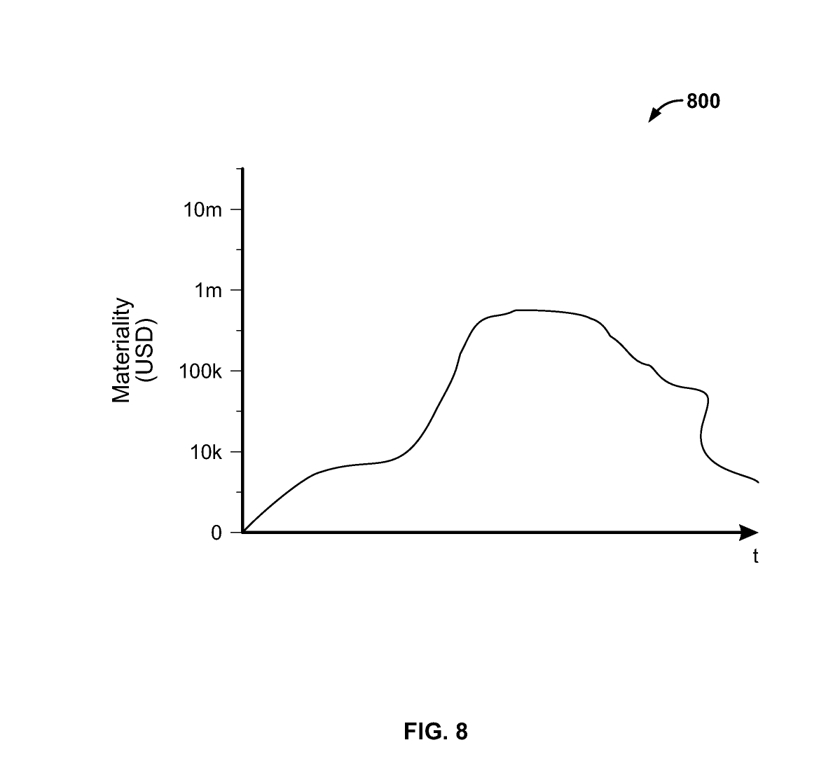

FIG. 8 shows illustrative graph 800. Graph 800 shows that materiality of a model-application pair in USD. Graph 800 shows that the materiality of the model-application pair may vary with time. For example, market movement, political events or other events may affect a materiality of a model-application pair.

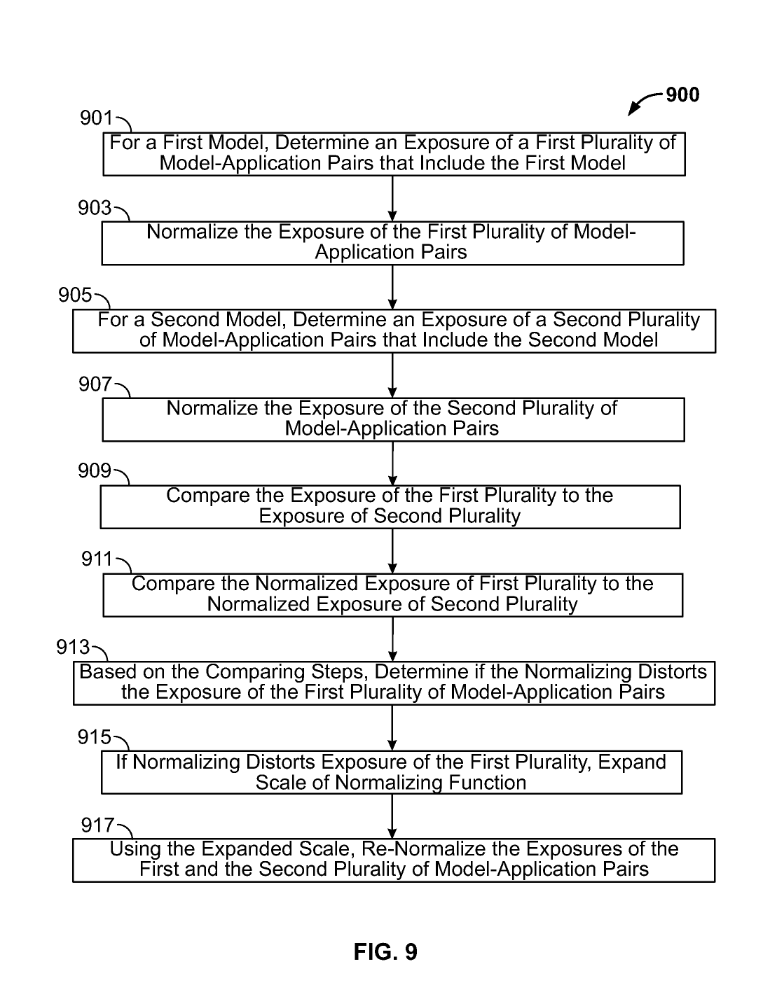

FIG. 9 shows illustrative process 900. For the sake of illustration, one or more of the steps of the process illustrated in FIG. 9 will be described as being performed by a “system.” The “system” may include one or more of the features of the apparatus, arrangements information or processes shown in FIGS. 1-8 and/or any other suitable device or approach. The “system” may be provided by an entity. The entity may be an individual, an organization or any other suitable entity.

Process 900 may begin at step 901. At step 901, the system may determine, for a first model, an exposure of a first plurality of model-application pairs that include the first model. At step 903, the system may normalize the exposure of the first plurality of model application pairs. At step 905, the system may determine, for a second model, an exposure of a second plurality of model-application pairs that include the second model. At step 907, the system may normalize the exposure of the second plurality of model-application pairs.

At step 909, the system may compare the exposure of first plurality to the exposure of second plurality. At step 911, the system may compare the normalized exposure of the first plurality to the normalized exposure of the second plurality. At step 913, based on a result of steps 909 and 911, the system may determine if the normalizing distorts the exposure of the first plurality of model-application pairs.

At step 915, if the normalizing distorts the exposure of first plurality, the system may expand a scale of a normalizing function. At step 917, using the expanded scale, the system may re-normalize the exposures of the first and the second plurality of model-application pairs.

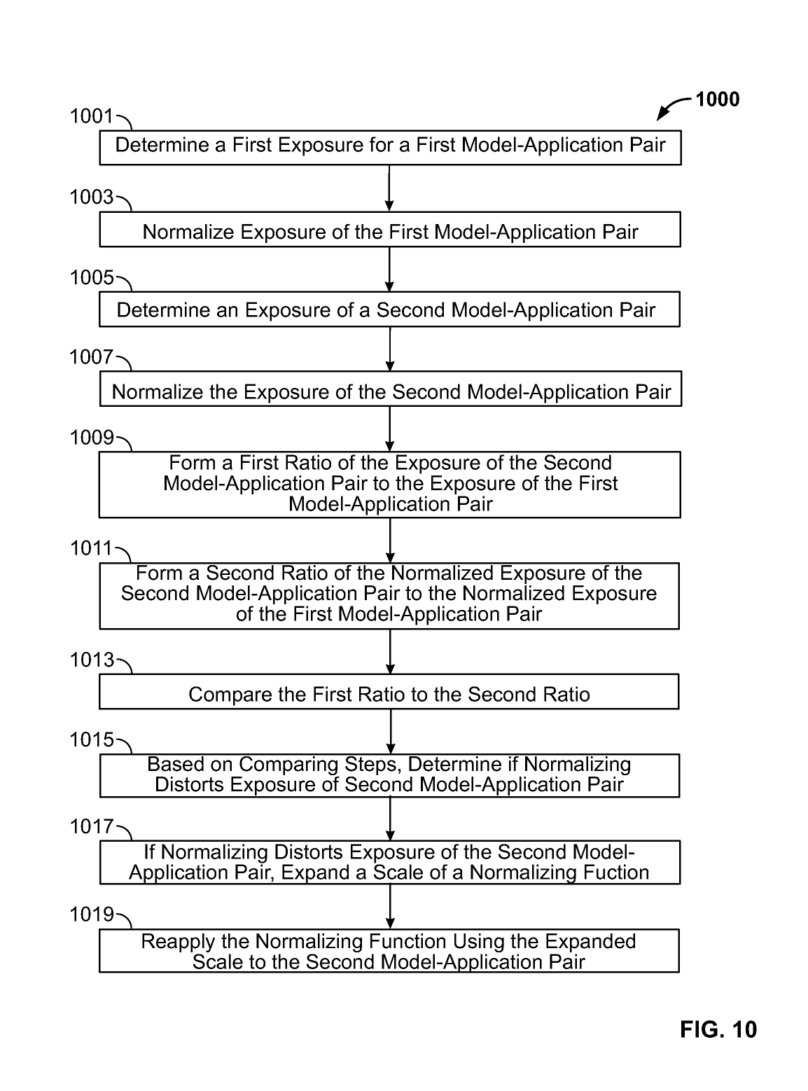

FIG. 10 shows illustrative process 1000. For the sake of illustration, one or more of the steps of the process illustrated in FIG. 10 will be described as being performed by a “system.” The “system” may include one or more of the features of the apparatus, arrangements, information or processes shown in FIGS. 1-9 and/or any other suitable device or approach. The “system” may be provided by an entity. The entity may be an individual, an organization or any other suitable entity.

At step 1001 the system may determine a first exposure for a first model-application pair. At step 1003, the system may normalize the exposure of the first model-application pair. At step 1005, the system may determine an exposure of a second model-application pair. At step 1007, the system may normalize the exposure of the second model-application pair.

At step 1009, the system may form a first ratio of the exposure of the second model-application pair to the exposure of the first model-application pair. At step 1011, the system may form a second ratio of the normalized exposure of the second model-application pair to the normalized exposure of the first model-application pair.

At step 1013 the system may compare the first ratio to the second ratio. At step 1015, based on a result of step 1013, the system may determine if applying a normalizing function distorts the exposure of the second model-application pair. At step 1017, if applying the normalizing function does distort the exposure of the second model-application pair, the system may expand a scale of the normalizing function. At step 1019, using the expanded scale, the system may reapply the normalizing function to the second model-application pair.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, apparatus and methods for model risk rating have been provided. Persons skilled in the art will appreciate that the present invention can be practiced by other than the described embodiments, which are presented for purposes of illustration rather than of limitation. The present invention is limited only by the claims that follow.

What is claimed is:

1. An article of manufacture comprising a non-transitory computer usable medium having computer readable program code embodied therein, the code when executed by one or more processors causing a computer to execute a method for determining a potential risk associated with a model, the method comprising calculating:
a complexity (“MC”) of the model;
a complexity (“AC”) of an application that utilizes the model to generate an output;
a normalized materiality (“M”) of the model to the application; and
a raw risk score corresponding to: MC*AC*M.

2. The article of claim 1, the method further comprising calculating:
a limitation (“L”) of the model when the model is utilized by the application;
a severity (“S”) associated with the L; and
a mitigation (“LM”) associated with the L.

3. The article of claim 2, the method further comprising calculating a final potential risk score corresponding to: MC*AC*M*S*LM.

4. The article of claim 3, the method further comprising, wherein, when the mitigation is one of a plurality of mitigations, the calculating of the final potential risk score is based on a maximum of the plurality of mitigations.

5. The article of claim 3 wherein, when the application is one of a plurality of applications that utilize the model, the method further comprising:
calculating the final potential risk score for each of the plurality of applications that utilizes the model; and
calculating a summation of the final potential risk score of each of the plurality of applications that utilizes the model.

7. The article of claim 5, further comprising calculating:
the AC for each of the plurality of applications that utilizes the model;
the M of the model to each of the plurality of applications that utilizes the model; and
the L of the model for each of the plurality of applications that utilizes the model.

8. The article of claim 1, wherein when the limitation is one of a plurality of limitations, the method further comprises:
determining which of the plurality of limitations apply to the model when the model is utilized by the application;
calculating the S for each of the plurality of limitations; and
calculating the final potential risk based on the severity of each of the plurality of limitations.

9. A computer program product for assigning a potential liability to a financial model, the computer program product comprising:
a non-transitory computer readable medium having computer readable program code embodied therein; and
a processor configured to execute the computer readable program code;
the computer readable program code when executed by the processor, for a financial model selected from among a plurality of financial models:
calculates a complexity associated with the financial model;
calculates a normalized materiality of an output generated when the financial model is embedded in an application;
calculates a complexity associated with the application;
determines a limitation associated with the financial model when the financial model is embedded in the application;
calculates a severity associated with the limitation;
calculates a mitigation associated with the limitation;
calculates a normalized potential liability score for the model based on a product of:
the complexity of the model;
the complexity of the application;
the normalized materiality;
the severity; and
the mitigation.

10. The computer program product of claim 9 further comprising computer readable program code that when executed by the processor, calculates a total potential liability score corresponding to a summation of the normalized potential liability scores of each of the plurality of financial models.

11. The computer program product of claim 9 wherein, when two or more of the plurality of financial models are embedded in the application, the computer readable program code when executed by the processor calculates a total potential liability score corresponding to a summation of the normalized potential liability score of the two or more financial models embedded in the application.

12. The computer program product of claim 9 wherein, when the plurality of models are embedded in a plurality of applications, the computer readable program code when executed by the processor calculates a total potential liability score corresponding to a summation of the normalized potential liability score for each of the plurality of models that is embedded in each of the plurality of applications.

13. The computer program product of claim 10 further comprising computer readable program code that when executed by the processor calculates the complexity associated with the application based on:
a payoff structure associated with the application;
a time sensitive attribute of the application;
an interdependency among two or more attributes of the application;
a pricing sensitivity associated with the output of the application; or
market observability of a value associated with the application.

14. The computer program product of claim 9 further comprising computer readable program code that when executed by the processor calculates the complexity associated with each of the plurality of models based on:
a number of inputs received by each model;
a number of stochastic variables of each model;
a relationship between the output of each model and observable behavior of an activity simulated by each model;
an effect of a change in input on the output of each model; or
an input density of each model.

15. A computer program product for assigning a potential risk measure to a model-application pair, the model-application pair comprising (1) an application that generates an output using the model and (2) the model, the computer program product comprising:
a non-transitory computer readable medium having computer readable program code embodied therein; and
a processor configured to execute the computer readable program code;
the computer readable program code when executed by the processor:
identifies a plurality of limitations associated with the model;
determines which of the plurality of limitations apply to the model-application pair;
calculates a severity for each of the plurality of limitations that apply to the model-application pair;
identifies a mitigation for each of the plurality of limitations that apply to the model-application pair;
calculates a normalized materiality of the model-application pair;
calculates a complexity of the model;
calculates a complexity of the application; and
calculates the potential risk measure for the model-application pair based on a product of:
the materiality;
the complexity of the model;
the complexity of the application;
the severity; and
the mitigation.

16. The computer program product of claim 15 further comprising computer readable program code that when executed by the processor is configured to:
identify a plurality of applications associated with the model;
determine a plurality of model-application pairs based on the plurality of applications associated with the model;
for each model-application pair, calculate the potential risk measure; and
calculate a summation of the potential risk measures of each of the plurality of model-application pairs.

17. The computer program product of claim 15, wherein when the model-application pair is one of a plurality of model-application pairs, the computer readable program code further comprising code that when executed by the processor:
calculates a normalized potential risk measure for each model-application pair; and
flags each model-application pair that is associated with a normalized risk measure above a threshold.

18. The computer program product of claim 15, wherein, when the mitigation is one of a plurality of mitigations, the computer readable program code that when executed by the processor calculates the potential risk measure based on a maximum mitigation of the plurality of mitigations.

19. The computer program product of claim 15 further comprising computer readable program code that when executed by the processor:
for each line-of-business (“LOB”) selected from among a plurality of LOBs operated by an entity, calculates a total potential risk measure for each of a plurality of model-application pairs associated with each LOB; and
identifies a LOB from among the plurality of LOBs that is associated with the total potential risk measure above a risk tolerance of the LOB.

20. The computer program product of claim 15 the computer readable program code further comprising code that when executed by the processor calculates the normalized materiality of the model-application pair as a function of a change in time.
